(19) United States
(12) Patent Application Publication
(10) Pub. No.: US 2025/0393076 A1
(43) Pub. Date: Dec. 25, 2025

(54) METHOD AND APPARATUS FOR HANDLING AMBIENT IOT UNSUCCESSFUL TRANSMISSION IN A WIRELESS COMMUNICATION SYSTEM

(71) Applicant: ASUS Technology Licensing Inc., Taipei City (TW)

(72) Inventors: Wei-Han Lai, Taipei City (TW); Ming-Che Li, Taipei City (TW); Yu-Hsuan Guo, Taipei City (TW); Yi-Hsuan Huang, Taipei City (TW); Meng-Hui Ou, Taipei City (TW)

(21) Appl. No.: 19/236,506

(22) Filed: Jun. 12, 2025

Related U.S. Application Data
(60) Provisional application No. 63/662,962, filed on Jun. 21, 2024.
(60) Provisional application No. 63/673,106, filed on Jul. 18, 2024.

(51) Int. Cl. H04W 74/0833; H04W 72/1263

(52) U.S. Cl. CPC H04W 74/0833; H04W 72/1263

(57) ABSTRACT

Methods, systems, and apparatuses are provided for handling Ambient Internet-of-Things (IoT) unsuccessful transmissions in a wireless communication system, wherein a method for a reader comprises transmitting a paging message triggering at least a first device to perform a random access procedure, receiving, from the first device, at least a first Msg1 transmission of the random access procedure, wherein the first Msg1 transmission includes an Identification (ID) associated with the first device, transmitting a first Msg2, of the random access procedure, including at least the ID, wherein the first Msg2 comprises at least a first scheduling information for a first Msg3 transmission, of the random access procedure, to be transmitted by the first device, transmitting a second Msg2, of the random access procedure, including at least the ID in response to failing to receive or decode at least the first Msg3 transmission, and receiving, in response to transmitting the second Msg2, at least the second Msg3 transmission of the random access procedure from the first device.

### CROSS-REFERENCE TO RELATED APPLICATIONS

The present Application claims priority to and the benefit of U.S. Provisional Patent Application Ser. No. 63/662,962, filed Jun. 21, 2024, and U.S. Provisional Patent Application Ser. No. 63/673,106, filed Jul. 18, 2024; with each of the referenced and listed applications and disclosures fully incorporated herein by reference.

### FIELD

This disclosure generally relates to wireless communication networks and, more particularly, to a method and apparatus for handling Ambient Internet-of-Things (IoT) unsuccessful transmissions in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling Ambient Internet-of-Things (IoT) unsuccessful transmissions in a wireless communication system. A network/reader can deal with Msg3 reception failure without introducing much latency or decoding effort to Ambient IoT devices.

In various embodiments, a method for a reader in a wireless communication system comprises transmitting a paging message triggering at least a first device to perform a random access procedure, receiving, from the first device, at least a first Msg1 transmission of the random access procedure, wherein the first Msg1 transmission includes an Identification (ID) associated with the first device, transmitting a first Msg2, of the random access procedure, including at least the ID, wherein the first Msg2 comprises at least a first scheduling information for a first Msg3 transmission, of the random access procedure, to be transmitted by the first device, transmitting a second Msg2, of the random access procedure, including at least the ID in response to failing to receive or decode at least the first Msg3 transmission, and receiving, in response to transmitting the second Msg2, at least the second Msg3 transmission of the random access procedure from the first device.

In various embodiments, a method of a first device in a wireless communication system comprises receiving a paging message triggering at least the first device to perform a random access procedure, performing a first Msg1 transmission of the random access procedure, wherein the first Msg1 transmission includes an ID associated with the first device, receiving (in response to performing the first Msg1 transmission) a first Msg2, of the random access procedure, including at least the ID, wherein the first Msg2 comprises at least a first scheduling information for a first Msg3 transmission, of the random access procedure, to be transmitted by the first device, performing, in response to receiving the first Msg2, the first Msg3 transmission, receiving a second Msg2, of the random access procedure, including at least the ID after performing the first Msg3 transmission, and performing, in response to receiving the second Msg2, a second Msg3 transmission.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5A is a reproduction of FIG. 9.2.6-1: Random Access Procedures—(a) CBRA with 4-step RA type, from 3GPP TS 38.300 V18.1.0.

FIG. 5B is a reproduction of FIG. 9.2.6-1: Random Access Procedures—(b) CBRA with 2-step RA type, from 3GPP TS 38.300 V18.1.0.

FIG. 5C is a reproduction of FIG. 9.2.6-1: Random Access Procedures—(c) CFRA with 4-step RA type, from 3GPP TS 38.300 V18.1.0.

FIG. 5D is a reproduction of FIG. 9.2.6-1: Random Access Procedures—(d) CFRA with 2-step RA type, from 3GPP TS 38.300 V18.1.0

FIG. 5E is a reproduction of FIG. 9.2.6-1: Random Access Procedures—(e) CFRA without network response with 4-step RA type, from 3GPP TS 38.300 V18.1.0.

FIG. 6 is a reproduction of FIG. 9.2.6-2: Fallback for CBRA with 2-step RA type, from 3GPP TS 38.300 V18.1.0.

FIG. 7 is an example diagram showing inventory operation utilizing slot-based ALOHA in RFID design, in accordance with embodiments of the present invention.

FIG. 8 is an example diagram showing that a reader may transmit a paging indicating a first device, a second device, and a third device and in response to (receiving) the paging, the first device may transmit a first Msg1 including a first ID, the second device may transmit a second Msg1 including a second ID, and the third device may transmit a third Msg1 including a third ID, in accordance with embodiments of the present invention.

FIG. 9 is a flow diagram of a method of a UE in a wireless communication system comprising receiving a first R2D message, in response to receiving the first R2D message, determining a first indication in a first D2R message, based on whether there is remaining data after transmitting the first D2R message, and transmitting the first D2R message comprising the first indication, in accordance with embodiments of the present invention.

FIG. 10 is a flow diagram of a method of a reader in a wireless communication system comprising transmitting a paging message triggering at least a first device to perform a random access procedure, receiving, from the first device, at least a first Msg1 transmission of the random access procedure, transmitting a second Msg2, of the random access procedure, including at least the ID in response to failing to receive or decode at least the first Msg3 transmission, and receiving, in response to transmitting the second Msg2, at least the second Msg3 transmission of the random access procedure from the first device, in accordance with embodiments of the present invention.

FIG. 11 is a flow diagram of a method of a first device in a wireless communication system comprising receiving a paging message triggering at least the first device to perform a random access procedure, performing a first Msg1 transmission of the random access procedure, receiving (in response to performing the first Msg1 transmission) a first Msg2, of the random access procedure, including at least the ID, performing, in response to receiving the first Msg2, the first Msg3 transmission, receiving a second Msg2, of the random access procedure, including at least the ID after performing the first Msg3 transmission, and performing, in response to receiving the second Msg2, a second Msg3 transmission, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-240826, “Revised SID: Study on solutions for Ambient IoT (Internet of Things) in NR”; [2] 3GPP TR 38.848 V18.0.0 (2023-09) 3GPP; TSG RAN; Study on Ambient IoT (Internet of Things) in RAN (Release 18); [3] 3GPP TS 38.300 V18.1.0 (2024-03) 3GPP; TSG RAN; NR; NR and NG-RAN Overall Description; Stage 2 (Release 18); [4] 3GPP TS 38.321 V18.1.0 (2024-03) 3GPP; TSG RAN; NR; MAC protocol specification (Release 18); [5] 3GPP TS 38.331 V18.1.0 (2024-03) 3GPP; TSG RAN; NR; RRC protocol specification (Release 18); [6] Draft Report of 3GPP TSG RAN WG2 meeting #126, Fukuoka, Japan (v1); [7] Draft Report of 3GPP TSG RAN WG1 #117 v0.2.0 (Fukuoka, Japan, May 20-24, 2024); [8] R1-2401937, “Final Report of 3GPP TSG RAN WG1 #116 v1.0.0 (Athens, Greece, Feb. 26-Mar. 1, 2024)”; and [9] EPC® Radio-Frequency Identity Generation-2 UHF RFID Standard, Specification for RFID Air Interface Protocol for Communications at 860 MHz-930 MHz, Release 3.0, Ratified, January 2024. The standards and documents listed above are hereby expressly and fully incorporated herein by reference in their entirety.

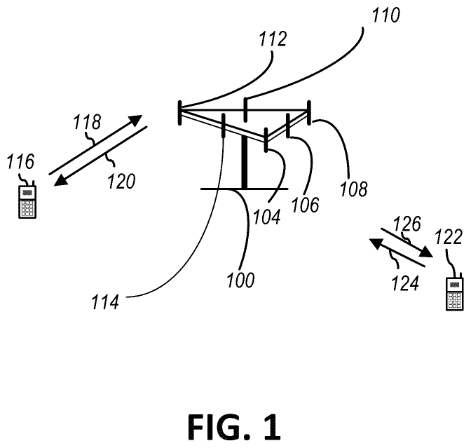

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

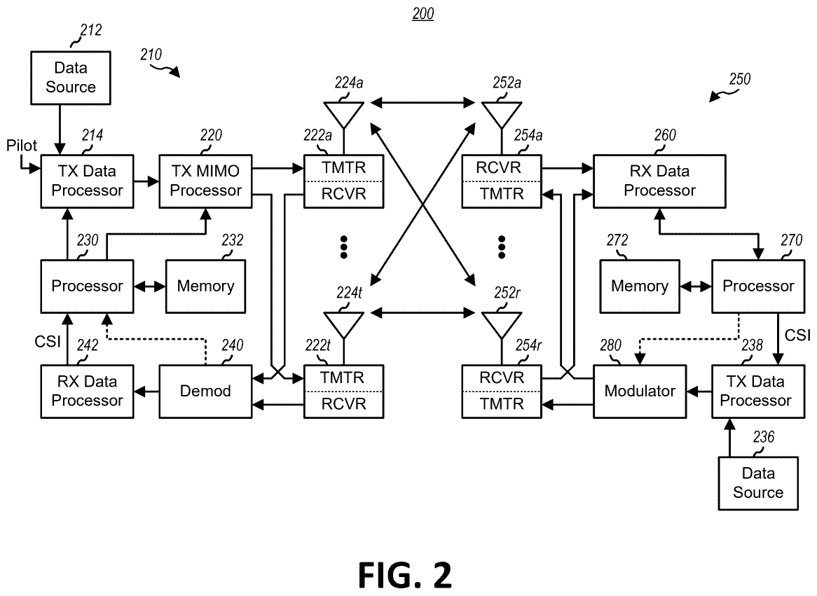

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

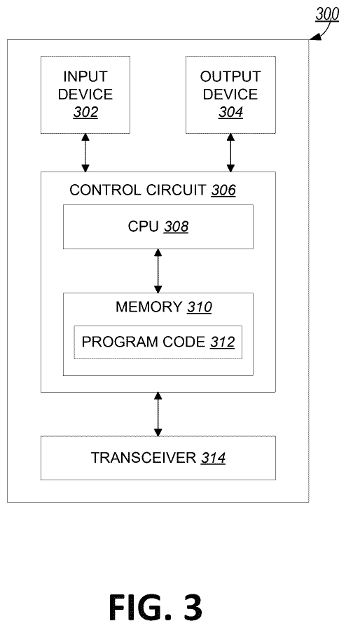

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

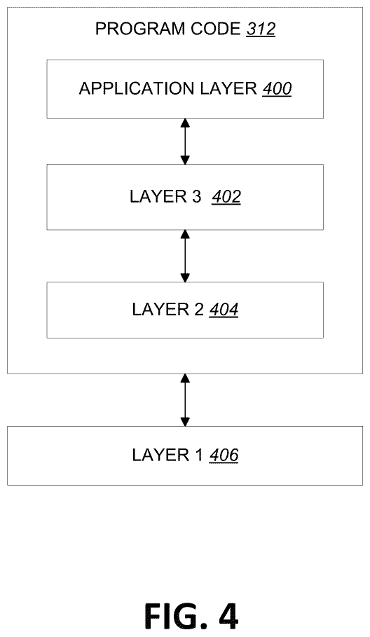

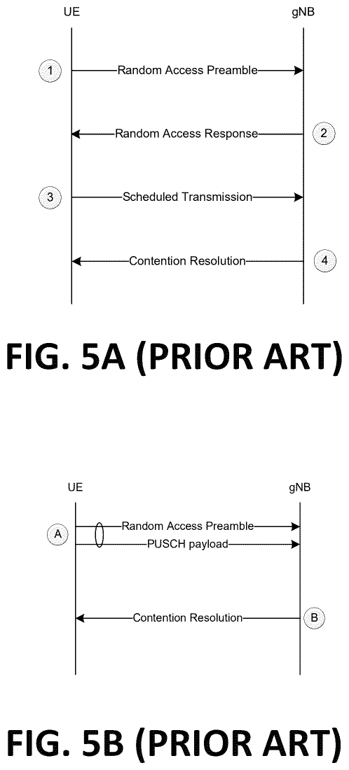

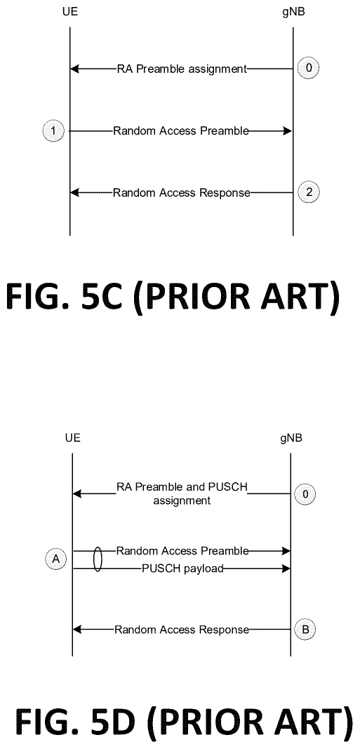

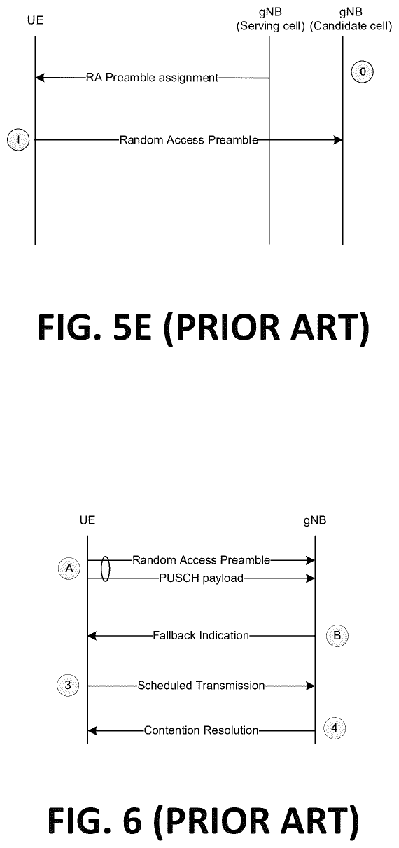

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of Ambient Internet of Things (IoT) is specified in [1] RP-240826:

In recent years, more devices are expected to be interconnected in the wireless communication world for improving productivity efficiency and increasing comforts of life. However, powering all the Internet-of-Things (IoT) devices by a battery that needs to be replaced or recharged manually would lead to high maintenance cost, environmental issues, and safety hazards for some use cases, e.g., wireless sensors in electrical power. Further reduction of size, complexity, and power consumption of IoT devices can enable the deployment for various applications (e.g., automated manufacturing, smart homes, etc.).

On the other hand, barcode and Radio Frequency Identification (RFID) have a limited reading range of a few meters, which usually requires handheld scanning. That would lead to labor intensive and time-consuming operations. Also, the lack of an interference management scheme would result in severe interference between RFID readers and capacity problems, especially in the case of dense deployment. It is hard to support a large-scale network with seamless coverage for RFID. In contrast, the study of Ambient IoT investigates the feasibility of a new IoT technology within 3GPP systems.

An Ambient IoT device/User Equipment (UE) would have ultra-low complexity, very small device size, and long life cycle. The Ambient IoT device/UE would have complexity and power consumption orders of magnitude lower than the existing 3GPP Low Power Wide Area (LPWA) technologies (e.g., Narrowband (NB)-IoT, enhanced Machine-Type Communication (eMTC)). The Ambient IoT device/UE may not have energy storage or may have energy storage. The energy of the Ambient IoT device/UE may be provided through the harvesting of radio waves, light, motion, heat, or any other power source that could be suitable. The energy and/or power source may be provided one-shot (e.g., unexpected or aperiodically), periodically, or continuously. In one embodiment, the power/energy of the Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The Uplink (UL) transmission of the Ambient IoT device/UE may be generated internally by the device/UE, or be backscattered on the carrier wave provided externally. More details regarding Ambient IoT (device/UE) could be found in the study item [1] RP-240826 and TR 38.848 ([2] 3GPP TR 38.848 V18.0.0 (2023-09)).

According to the study item of Ambient IoT ([1] RP-240826), an Ambient IoT UE has limited energy storage (possibly even with no energy storage). Comparing a New Radio (NR) UE with power consumption of mW (e.g., maximum UE transmit power 23 dBm corresponds to 199.5 mW), output power of the Ambient IoT UE may be typically from 1 μ W to a few hundreds of μ W. Currently, the general scope is to address the following types of Ambient IoT UEs:
A first type of Ambient IoT UE may have 1μ W peak power consumption, with energy storage, with neither Downlink (DL) nor UL amplification. Transmission from the first type of Ambient IoT UE may be backscattered on a carrier wave provided externally. The first type of Ambient IoT UE may be a type of device 1, e.g., as described in [8] R1-2401937.
A second type of Ambient IoT UE may have ≤ a few hundred μ W peak power consumption, with energy storage, with DL and/or UL amplification. Transmission from the second type of Ambient IoT UE may be backscattered on a carrier wave provided externally (e.g., a type of Device 2a ) or generated internally by the UE (e.g., a type of Device 2b). The second type of Ambient IoT UE may be a type of Device 2a and/or Device 2b, e.g., as described in [8] R1-2401937.

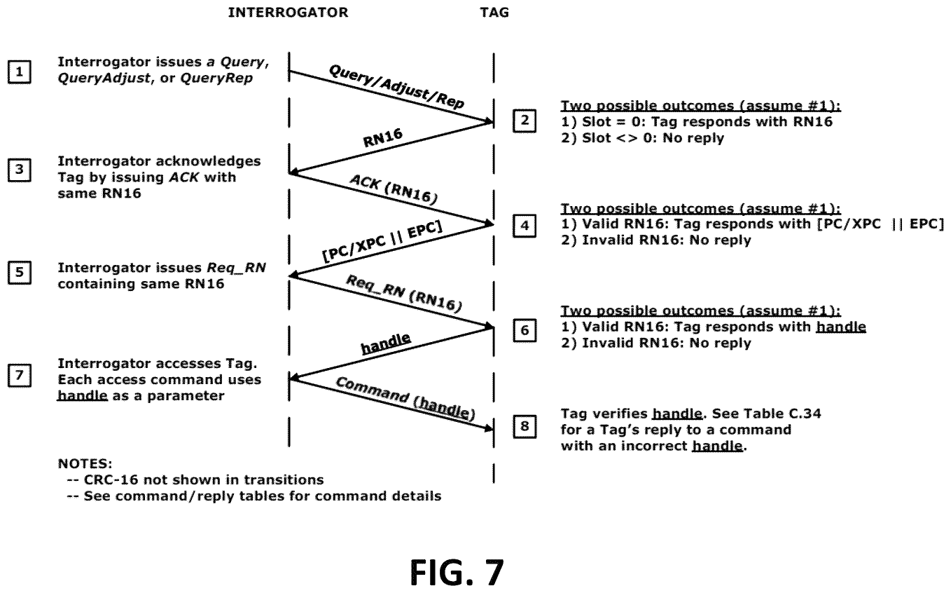

In RFID design ([9] EPC® Radio-Frequency Identity Generation-2 UHF RFID Standard, Specification for RFID Air Interface Protocol for Communications at 860 MHz-930 MHz, Release 3.0, Ratified, January 2024), inventory operation utilizes slot-based ALOHA, as instance shown in FIG. 7.

### Step 1

An interrogator sends a Query command to a tag population, wherein the Query command indicates a Q value, indication of Selected/Select Flag (SL) flag selection, session indication, and Target indication of inventoried flag. One or more tags matching the indicated SL flag and inventoried flag will perform inventory operation and randomly generate a slot number among 0 to (2^{Q} −1) in response to the Query command. The interrogator may send one or more Select commands, before the Query command, to set SL flags and inventoried flags of the tag population based on a condition on Memory Bank and a mask bit-string indicated by each Select command. In other words, the Interrogator may select a tag sub-population to perform inventory operation, instead of full tag population. Besides, within one inventory round initialized by the Query command, the interrogator can send one or more Queryadjust commands to adjust a Q value and/or send one or more QueryRep commands for reducing the slot number of the tag sub-population.

### Step 2

The one or more tags maintain their slot number and will reduce their slot number by 1 when receiving the QueryRep command from the Interrogator. When the slot number of a tag is equal to zero, the tag will send a randomly generated 16-bit, i.e., RN16, to the interrogator. In other words, the randomly generated slot numbers will normally distribute the tag sub-population into different slot occasions, such that the one or more tags of the tag sub-population will not send their RN16 at the same time with severe collision. Once more than one tag generates the same slot number, it will depend on the Interrogator implementation to distinguish them if feasible.

### Step 3

When the Interrogator detects an RN16 signaling from a tag, the interrogator sends an Acknowledgement (ACK) command with the detected RN16.

### Step 4

The tag sending its RN16 in step 2 will detect or receive the ACK command in step 3. If the ACK command indicates the same RN16, the tag will be considered as acknowledged and will send its tag information to the interrogator, e.g., Electronic Product Code (EPC) or any code for identification. It is because the RN16 is just a temporary identity, the interrogator does not yet acquire real information for identifying the tag. If the ACK command does not indicate the same RN16, the tag will not be considered as acknowledged and will not reply anything.

### Step 5

When the interrogator receives the tag information for identifying the tag, it means that the interrogator inventories the tag successfully. If there is no need for further data delivery between the interrogator and the inventoried tag, the interrogator may send a QueryRep command to let other tags reduce their slot number, i.e., go back to step 1 for other tags. If there is a need for further data delivery between the interrogator and the inventoried tag, the interrogator will start an access operation and send a Req_RN command to the inventoried tag.

### Step 6

When the tag receives a Req_RN command with valid the RN16 utilized in previous steps, the tag will start to perform an access operation and generate a new random 16-bit, denoted as a handle, and send it to the interrogator. More specifically, the RN16 is a temporary identity for inventory operation, and the handle is an identity for access operation.

### Step 7

After the interrogator acquires the handle from the inventoried tag, the interrogator can send one or more access commands to the tag for communication, e.g., scheduling data transmission from the tag to the interrogator, security management, the tag's file management.

### Step 8

When the tag receives an access command with a valid handle, the tag will report/reply accordingly. Note that step 7 and step 8 can be performed multiple times until the interrogator ends the communication (i.e., ends the access operation with the tag) by issuing any of Select, Challenge, Query, QueryX, Query Adjust, QueryRep, or a Negative Acknowledgement (NAK/NACK) command.

In an example for Ambient IoT design, the device may receive an initial trigger message (e.g., an Ambient IoT (AIoT) paging message, a first (Ambient IoT) Reader-to-Device (R2D) message) from the network/reader. In response to (or after) receiving the initial trigger message, the device may trigger an access procedure and transmit a Msg1 (e.g., a first (Ambient IoT) Device-to-Reader (D2R) message, a message in response to the initial trigger message) to the network/reader. Msg1 may be transmitted using resources indicated by the initial trigger message. In response to (or after) transmitting the Msg1, the device may receive a Msg2 (e.g., a second R2D message, a message in response to the Msg1) from the network/reader. In response to receiving the Msg2, the device may or may not transmit a Msg3 (e.g., a second D2R message, a message in response to the Msg2, a subsequent D2R transmission of the initial access procedure) to the network/reader. Msg3 may be transmitted using resources indicated by the Msg2. In response to (or after) transmitting the Msg3, the device may receive a Msg4 (e.g., a third R2D message, a message in response to the Msg3, a subsequent R2D transmission of the initial access procedure) from the network/reader. The access procedure may be successfully completed and/or be considered as successful in a transmission/reception/contention resolution, after/upon/in response to the device receiving the corresponding Msg2 or Msg4 (e.g., the corresponding Msg2 or Msg4 indicates the device or some information the device has transmitted). The access procedure may be successfully completed and/or be considered as successful in the transmission/reception/contention resolution, after/upon/in response to the corresponding (subsequent) R2D transmission(s) and/or the corresponding (subsequent) D2R transmission(s) are successful and/or completed.

For a contention-based access procedure (e.g., 4-step and/or 2-step), the reader may send an initial trigger message (e.g., an AIoT paging message, an R2D message to trigger the access procedure) including device Identification(s)/Identity(ies) (ID(s)) and/or (a set of common) resources for consequent D2R transmissions. The initial trigger message may be or comprise a command and/or an inventory message. More than one device may select a resource (from the set of common resources) to perform the consequent D2R transmission (e.g., Msg1). If (at least) more than one device selects the same resource, at most one device may be considered that the transmission/reception/contention resolution is successful. In other words, more than one device is indicated via the device ID(s) included in the trigger message. Each device of the more than one device may select a resource (from the set of common resources) to perform the corresponding D2R transmission (e.g., Msg1). If two or multiple devices select the same resource, the reader may successfully receive/decode zero or at most one D2R transmission from the two or multiple devices. The reader may indicate (e.g., in Msg2) which device is successful in the transmission/reception/contention resolution. The reader may perform an R2D transmission (e.g., Msg2) to indicate which D2R transmission (e.g., Msg1) (or from which device) is successfully received, e.g., indicate one or more bit information (e.g., a random ID) included in the received D2R transmission, if any). The device associated with the indicated one or more bit information may be considered as successful in the transmission/reception/contention resolution. The device associated with the indicated one or more bit information may perform another D2R transmission (e.g., Msg3) corresponding to the R2D transmission (e.g., Msg2). Other devices not associated with the indicated one or more bit information may be considered as failed/unsuccessful in the transmission/reception/contention resolution. The device receiving the Msg2 (indicating corresponding (ID) of the device in Msg1) may be considered as successful in the transmission/reception/contention resolution. The device receiving the Msg2 (indicating corresponding ID of the device in Msg1) may perform another D2R transmission (e.g., Msg3) corresponding to the R2D transmission (e.g., Msg2). Other devices not receiving the Msg2 (indicating a corresponding ID of the device in Msg1) may be considered as failed/unsuccessful in the transmission/reception/contention resolution. Other device(s) receiving the Msg2 without indicating a corresponding ID of the other device(s) may be considered as failed/unsuccessful in the transmission/reception/contention resolution. The failed devices (i.e., failed/unsuccessful in the transmission/reception/contention resolution, or not indicated in the corresponding Msg2), other than the successful device, may not perform the consequent D2R transmission (e.g., Msg3) and/or R2D reception (e.g., Msg4) (e.g., in the same (or current) access procedure). The reader does not realize the total number of failed device(s) and/or the corresponding device ID(s) of the failed device(s). The failed devices may still need to perform the access procedure by performing a D2R retransmission (e.g., Msg1 (re)transmission). However, the resource(s) for the D2R retransmission is not provided (or indicated). There is an issue on how the failed device(s) acquire resources for performing the D2R retransmissions.

On the other hand, the device may not always (be able to) respond to a R2D message due to limited power storage. For example, the device may (be required/expected to) perform a D2R transmission in response to an R2D command/inventory message. The device may not be able to perform the D2R transmission because there is not enough power to keep the device on (or to receive the 2D message/to process the received message/to perform the D2R transmission). In this case, the reader may consider the R2D transmission failed/unsuccessful (e.g., failed/unsuccessful in the device's reception) and perform a retransmission. However, the device may not be able to perform the consequent D2R transmission if (at least) the power shortage still occurs. As a result, the retransmission may only cause signaling overhead and power waste for the reader. In this case, the reader may possibly consider the device with insufficient power, but the reader does not know when to perform R2D retransmissions.

In a NR random access procedure, there are cases that the network sends a Msg2, but does not receive or decode Msg3 successfully. For example, the UE transmits Msg3 in response to the Msg2, but the network fails to receive the Msg3. In this case, the network will transmit a Physical Downlink Control Channel (PDCCH) scrambled by a Temporary Cell Radio Network Temporary Identifier (TC-RNTI) to schedule The UE to retransmit the Msg3. For another example, the UE could fail to receive the Msg2. In this case, the UE would perform Random Access (RA) resource selection to perform re-access. These cases could also happen in an Ambient IoT random access procedure. However, if a similar signaling is designed as PDCCH scrambled by a Temporary C-RNTI to trigger Msg3 retransmission, it would require multiple unicast signalings, which would induce specification impact, decoding complexity, and power consumption of Ambient IoT devices. Besides, if R2D does not support Frequency-Division Multiple Access (FDMA), latency would be further induced to schedule each failed device's Msg3 re-transmission. On the other hand, the reader may schedule other successful device(s) with following transmissions first. The failed device(s) have to wait for the subsequent paging to re-access to the reader, since the UE-triggered Msg1 transmission (e.g., Device-Originated-Autonomous (DO-A) transmission) is not applicable for (e.g., R19) an Ambient IoT device. This approach would induce latency for the failed device(s). Therefore, a proper method for the network to solve Msg3 reception failure is needed.

It was agreed in 3GPP meetings that for a (4-step) contention-based access procedure, the reader may send an initial trigger message (e.g., Msg0). The device may send a first D2R message (e.g., Msg1) including (at least) a random ID generated by the device (e.g., randomly generated or generated based on Device ID). The reader may (at least) echo the random ID (received in Msg1), after (or in response to) receiving the first D2R message (e.g., Msg1), via transmitting a first R2D message (e.g., Msg2). That is, the device may consider the transmission/reception/contention resolution successful if (at least) the first R2D message (e.g., Msg2) includes/indicates the same random ID in the first D2R message (e.g., Msg1). The device may send (at least) a device ID (different from the random ID in Msg1) in a second D2R message (e.g., Msg3), after (or in response to) receiving the first R2D message (e.g., Msg2). The reader may or may not send a second R2D message (e.g., Msg4) after (or in response to) receiving the second D2R message (e.g., Msg3).

Additionally in certain embodiments, for a 2-step contention based access procedure, the reader may send an initial trigger message (e.g., Msg0). The device may send a D2R message (e.g., Msg1) including (at least) an ID and/or other upper layer data. The reader may (at least) echo the ID (received in Msg1) after (or in response to) receiving the D2R message (e.g., Msg1), via transmitting an R2D message (e.g., Msg2). That is, the device may consider the transmission/reception/contention resolution successful if (at least) the R2D message (e.g., Msg2) includes/indicates the same ID in the D2R message (e.g., Msg1).

It is also assumed that a corresponding D2R transmission may be required (or expected) after (or in response to) an R2D transmission if (at least) the device ID has been acquired/identified by the reader (e.g., the device has been inventoried). The scheduling information for the (corresponding) D2R transmission may be provided by the R2D transmission.

The reader may initiate an access procedure on/for one or more devices. The reader may indicate which device(s) to perform the access procedure by including information of a target device(s) in an initial trigger message. The information of the target device(s) may comprise any of a (target) device ID(s), group ID(s), type of devices, one or more conditions for filtering/determining target devices (e.g., any devices satisfying the one or more conditions may be considered as target devices).

Preferably in certain embodiments, the initial trigger message may include scheduling information to derive a (time/frequency) resource for a corresponding (first) D2R transmission (e.g., Msg1), wherein the resource may be dedicated to the device(s)/group(s) (e.g., contention-free). For example, an initial trigger message may include multiple (e.g., n) device ID(s) and multiple resource(s) (associated with the multiple devices). The association/mapping between the multiple device IDs and the multiple resources may be specified or indicated by the initial trigger message. A first resource (indicated in the initial trigger message) may be used for a first device (indicated in the initial trigger message) (to perform a corresponding (first) D2R transmission); a second resource (indicated in the initial trigger message) may be used for a second device (indicated in the initial trigger message) (to perform the corresponding (first) D2R transmission). The first resource may be different from the second resource.

Alternatively in certain embodiments, the initial trigger message may include scheduling information to derive a set of (time/frequency) resources for corresponding (first) D2R transmissions (e.g., Msg1), wherein the set of resources may be a set of common resources (e.g., contention-based). For example, an initial trigger message may include several (e.g., m) of resources. A first device (to perform the access procedure) may select a first resource, among the set of resources (indicated in the initial trigger message), for performing the corresponding (first) D2R transmission. A second device (to perform access procedure) may select a second resource, among the set of resources (indicated in the initial trigger message), for performing corresponding the (first) D2R transmission. The first resource may or may not be the same as the second resource.

In the case that the initial trigger message includes scheduling information for the set of common resources, a device may perform a (first) D2R transmission (e.g., Msg1) with a selected resource, wherein the (first) D2R transmission includes (at least) an ID (e.g., generated by the device). If more than one device selected the same resource, contention may occur. At most one (first) D2R transmission corresponding to each (selected) resource may be successfully received/decoded by the reader. For example, a first device (to perform an access procedure) may select a first resource, among the set of common resources, for performing a corresponding (first) D2R transmission. A second device (to perform access procedure) may select a second resource, among the set of common resources, for performing the corresponding (first) D2R transmission. A third device (to perform access procedure) may select the first resource, among the set of common resources, for performing the corresponding (first) D2R transmission. The reader may successfully receive/decode the corresponding (first) D2R transmission from the second device. The reader may successfully receive/decode one of the corresponding (first) D2R transmissions from the first device and third device. The reader may not successfully receive/decode the other of the corresponding (first) D2R transmissions from the first device and third device. The reader may transmit an R2D message (e.g., Msg2) after (or in response to) the received/decoded (first) D2R transmission(s).

The R2D message may be associated with (a single) one (D2R) (time/frequency) resource (e.g., resource of Msg1). For example, the R2D message may include (a single) one device ID (e.g., which is successful in transmission/reception/contention resolution on the (selected) D2R (time/frequency) resource). Preferably in certain embodiments, one R2D message may comprise a response to one received/detected (first) D2R transmission (e.g., Msg1) on one D2R resource. Alternatively and/or additionally, the R2D message may be associated with multiple (D2R) (time/frequency) resources (e.g., multiple resources of multiple Msg1s). For example, the R2D message may include multiple device IDs (e.g., which are successful in transmission/reception/contention resolution on each (selected) D2R (time/frequency) resource). Preferably in certain embodiments, one R2D message may comprise response(s) to multiple received/detected (first) D2R transmissions (e.g., Msg1) on multiple D2R resources. The R2D message may be associated with the D2R resource(s) if (at least) the D2R message is transmitted on a specific frequency domain resource. Preferably in certain embodiments, one R2D message may comprise response(s) to multiple received/detected (first) D2R transmissions (e.g., Msg1) on multiple D2R resources, wherein the multiple D2R resources are on the same frequency domain resources (and in different time domain resources). The R2D message may be associated with D2R resource(s) if (at least) the D2R message is transmitted on a specific time domain resource. Preferably in certain embodiments, one R2D message may comprise response(s) to multiple received/detected (first) D2R transmissions (e.g., Msg1) on multiple D2R resources, wherein the multiple D2R resources are on the same time domain resources (and in different frequency domain resources).

The R2D message may include/indicate the association of the R2D message and the (one or multiple) D2R (time/frequency) resource(s) (e.g., resource of Msg1). For example, an R2D message may include/indicate the association of the R2D message and (one or multiple) D2R (time/frequency) resource(s) implicitly. The R2D message may be associated with the D2R resource(s) which has/uses/occupies the same frequency resource. The R2D message may be associated with the D2R resource(s) which has/uses/occupies the same time resource. For another example, an R2D message may include/indicate the association of the R2D message and (one or multiple) D2R (time/frequency) resource(s) with an indicator. The indicator in the R2D message may indicate (one or more) (resource) index(es) of the associated D2R resource(s). The indicator may indicate (one or more) frequency index(es) that the associated D2R resource(s) uses/occupies. The indicator may indicate (one or more) time index(es) that the associated D2R resource(s) uses/occupies.

The R2D message may be transmitted via one or more R2D transmissions. The device may be considered to be successful in transmission/reception/contention resolution if (at least) the ID (provided in the (first) D2R transmission) is included in the R2D message (associated with the selected D2R (time/frequency) resource). The device(s) may be considered to fail in transmission/reception/contention resolution if (at least) the ID (provided in the (first) D2R transmission) is not included in the R2D message (associated with the selected D2R (time/frequency) resource).

For the device (e.g., successful in transmission/reception/contention resolution), the (associated) R2D message may include a (time/frequency) resource for a corresponding (second) D2R transmission (e.g., Msg3), wherein the resource may be dedicated to the device. For example, the R2D message may include several device ID(s) and the corresponding resource(s). Each device (whose ID is) indicated in the (associated) R2D message was successful in transmission/reception/contention resolution (e.g., a first device selected a first resource for the first D2R transmission; a second device selected a second resource for the first D2R transmission, wherein the second resource may not be the same as the first resource). A third resource (indicated in the R2D message) may be used for the first device (indicated in the R2D message) (to perform a corresponding (second) D2R transmission); a fourth resource (indicated in the R2D message) may be used for the second device (indicated in the R2D message) (to perform the corresponding (second) D2R transmission). The third resource may be different from the fourth resource.

For the device(s) (e.g., failed/unsuccessful in transmission/reception/contention resolution), the (associated) R2D message may include one or more (time/frequency) resources for another (first) D2R transmission (e.g., Msg1 retransmission), wherein the one or more resources may be a set of common resources. For example, the R2D message may include several (e.g., m′) of resources, e.g., a fifth resource, sixth resource, and/or seventh resource. A third device (failed/unsuccessful in the transmission/reception/contention resolution since it selected the first resource as the first device did) may select a fifth resource (indicated in the R2D message). A fourth device (failed/unsuccessful in the transmission/reception/contention resolution since it selected the second resource as the second device did) may select a sixth resource (indicated in the R2D message). The fifth resource may or may not be the same as the sixth resource. Preferably in certain embodiments, the first device (if failed/unsuccessful in the transmission/reception/contention resolution since it selected the first resource as the third device did) may select a seventh resource (indicated in the R2D message).

The resource for a corresponding (second) D2R transmission (e.g., for the device(s) successful in the transmission/reception/contention resolution) (e.g., Msg3) and the resource(s) for another (first) D2R transmission (e.g., for the device(s) failed/unsuccessful in the transmission/reception/contention resolution) (e.g., Msg1 retransmission) may be differentiated or different or exclusive. For example, the third resource and/or the fourth resource (dedicated for the devices successful in the transmission/reception/contention resolution) may not be selected/utilized by the third and/or the fourth device. The fifth resource and/or the sixth resource (common for the device failed/unsuccessful in the transmission/reception/contention resolution) may not be selected by the first device (e.g., if successful in transmission/reception/contention resolution) and/or the second device.

The resource for a corresponding (second) D2R transmission (e.g., for the device(s) successful in transmission/reception/contention resolution) (e.g., Msg3) and the resource(s) for another (first) D2R transmission (e.g., for the device(s) failed/unsuccessful in the transmission/reception/contention resolution) (e.g., Msg1 retransmission) may be differentiated implicitly. For example, the R2D message may include several (e.g., n) device ID(s) and several (e.g., k) of resources (where k is larger or equal to n). The first n (i.e., 1^{st}˜n-th) resources may be used for devices successful in the transmission/reception/contention resolution. The rest of the resources (i.e., (n+1)-th˜k-th) may be common for the devices failed/unsuccessful in the transmission/reception/contention resolution.

Alternatively and/or additionally, the resource for a corresponding (second) D2R transmission (e.g., for the device(s) successful in the transmission/reception/contention resolution) (e.g., Msg3) and the resource(s) for another (first) D2R transmission (e.g., for the device(s) failed/unsuccessful in the transmission/reception/contention resolution) (e.g., Msg1 retransmission) may be differentiated with an indicator in the R2D message. The R2D message may include information for a device to differentiate between the resource(s) for the device(s) successful in the transmission/reception/contention resolution and the resource(s) for the device(s) failed/unsuccessful in the transmission/reception/contention resolution. The information may indicate whether a resource is for a device(s) successful in the transmission/reception/contention resolution or for a device(s) failed/unsuccessful in the transmission/reception/contention resolution. The information may indicate whether a resource is for Msg3 transmission or Msg1 (re)transmission. For example, there may be a one-bit indicator associated with each resource indicated in the R2D message. If (at least) the indicator is 1, the associated resource may be indicated for the device successful in the transmission/reception/contention resolution. If (at least) the indicator is 0, the associated resource may be used for the device that failed/unsuccessful in the transmission/reception/contention resolution. The resources associated with the indicator 0 may be associated with a device ID (for the device(s) successful in the transmission/reception/contention resolution). The resources associated with the indicator 1 may be or may not be associated with a device ID (for the device(s) that failed/unsuccessful in the transmission/reception/contention resolution). For another example, if (at least) the indicator is 0, the associated resource may be indicated for the device successful in the transmission/reception/contention resolution. If (at least) the indicator is 1, the associated resource may be used for the device that failed/unsuccessful in the transmission/reception/contention resolution. The resources associated with the indicator 1 may be associated with a device ID (for the device(s) successful in the transmission/reception/contention resolution). The resources associated with the indicator 0 may be or may not be associated with a device ID (for the device(s) that failed/unsuccessful in the transmission/reception/contention resolution).

Preferably in certain embodiments, the device performing the (first) D2R transmission receives the corresponding R2D message. The R2D message may include/indicate some ID information received in (first) D2R transmissions from one or multiple devices and/or some transmission information of successfully received/decoded (first) D2R transmissions. The R2D message may include a first one or more resources and a second one or more resources. The first one or more resources may be utilized for the device(s) identified by the (some) ID information and/or the (some) transmission information. The second one or more resources may be utilized for the device(s) which are not identified by the (some) ID information and/or the (some) transmission information. Preferably in certain embodiments, when the device is identified by the (some) ID information and/or the (some) transmission information, the device may perform a corresponding (second) D2R transmission on a resource among the first one or more resources (and, the device may not perform another (first) D2R transmission on any resource among the second one or more resources). The R2D message may provide (one-to-one) association/mapping between the first one or more resources and the (some) ID/transmission information. The R2D message may provide (one-to-one) association/mapping between the first one or more resources and one or more devices identified by the (some) ID/transmission information. Preferably in certain embodiments, when the device is not identified by the (some) ID information and/or the (some) transmission information, the device may perform another (first) D2R transmission on a resource among the second one or more resources (and, the device may not perform any corresponding (second) D2R transmission on any resource among the first one or more resources).

Preferably in certain embodiments, the resource for the corresponding (second) D2R transmission (e.g., for the device(s) successful in the transmission/reception/contention resolution) (e.g., Msg3) and the resource(s) for another (first) D2R transmission (e.g., for the device(s) that failed/unsuccessful in the transmission/reception/contention resolution) (e.g., Msg1 retransmission) may be transmitted/delivered/scheduled/allocated via separate R2D transmissions. Preferably in certain embodiments, the first one or more resources and the second one or more resources may be transmitted/delivered/scheduled/allocated via separate R2D transmissions. Preferably in certain embodiments, the reader may perform a first R2D transmission comprising information of the resource for the corresponding (second) D2R transmission (e.g., for the device(s) successful in the transmission/reception/contention resolution) (e.g., Msg3) and/or the (some) ID/transmission information. The reader may perform the first R2D transmission comprising information of the first one or more resources and/or the (some) ID/transmission information. Preferably in certain embodiments, the reader may perform a second R2D transmission comprising information of the resource(s) for another (first) D2R transmission (e.g., for the device(s) that failed/unsuccessful in the transmission/reception/contention resolution) (e.g., Msg1 retransmission). The reader may perform the second R2D transmission comprising information of the second one or more resources.

Alternatively in certain embodiments, for the device(s) that failed/unsuccessful in the transmission/reception/contention resolution, the R2D message may not include a (time/frequency) resource for another (first) D2R transmission (e.g., Msg1 retransmission) (at least for the device(s)). The device(s) may not use (time/frequency) resource for D2R transmission (e.g., Msg1 retransmission) included in (or derived by) the R2D message if (at least) the device(s) that failed/unsuccessful in the transmission/reception/contention resolution. The device(s) may perform another (first) D2R transmission (e.g., Msg1 retransmission) upon receiving an (another) initial trigger message. The device(s) may perform another (first) D2R transmission (e.g., Msg1 retransmission) with the resource indicated in the (another) initial trigger message. The (another) initial trigger message may be sent by the reader after the device(s) successful in the transmission/reception/contention resolution completes the access procedure(s) (e.g., after the corresponding D2R transmission(s) and/or the corresponding R2D transmission(s)). Alternatively and/or additionally, the (another) initial trigger message may be sent by the reader after the transmission/reception/contention resolution. Alternatively and/or additionally, the (another) initial trigger message may be sent by the reader at a time after the transmission/reception/contention resolution and before the completion of the access procedure (for the devices successful in the transmission/reception/contention resolution).

One or more of the above embodiment(s), concept(s), method(s), and/or example(s) of resource indication could be combined, in whole or in part, or applied/used separately.

To solve the issue, the reader could re-send a Msg2 indicating device(s) whose Msg3 is not received and/or decoded successfully by the reader. During a random access procedure, the reader may indicate Ambient IoT device(s) to perform Msg3 transmission by including corresponding ID(s) in a Msg2, wherein the corresponding ID(s) is the random ID(s) sent in Msg1. In response to (receiving) the Msg2, the indicated device(s) may transmit Msg3(s) and monitor Physical Reader (to Ambient IoT) Device Channel(s) (PRDCH(s)) for subsequent R2D message(s), respectively. The reader may determine whether the Msg3(s) are received and decoded successfully. The reader may transmit another Msg2 which includes the ID(s) corresponding to failed device(s) (e.g., the reader does not receive or decode Msg3 successfully). In response to (receiving) the another Msg2, the (failed) device(s) would perform Msg3 (re-)transmission if its random ID is included in the another Msg2.

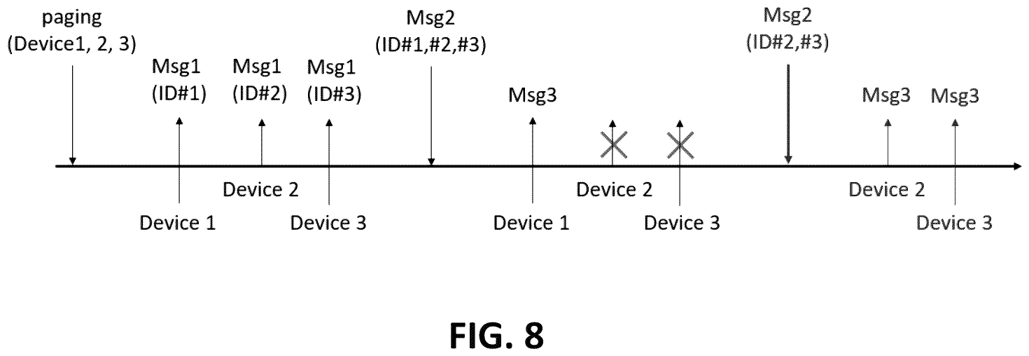

An example is shown in FIG. 8. The reader may transmit a paging indicating a first device, a second device, and a third device. The paging may indicate/trigger the first device, the second device, and the third device to trigger/initiate a random access (procedure). In response to (receiving) the paging, the first device may transmit a first Msg1 including a first ID, the second device may transmit a second Msg1 including a second ID, and the third device may transmit a third Msg1 including a third ID. The first ID, second ID, and third ID are random IDs generated/selected by the corresponding device. In response to (receiving) the first Msg1, the second Msg1 and the third Msg1, the reader may transmit a first Msg2 including the first ID, the second ID, and the third ID, e.g., if the three devices/Msg1s are considered as contention resolution and/or are not collided. In response to (receiving) the first Msg2, the first device may transmit a first Msg3, the second device may transmit a second Msg3, and the third device may transmit a third Msg3. In response to (receiving) the first Msg3, the second Msg3, and/or the third Msg3, the reader may transmit a second Msg2 including the second ID and third ID, based on: the first Msg3 is decoded/received successfully, the second Msg3 is not decoded/received successfully, the third Msg3 is not decoded/received successfully, the second Msg3 is considered as failed/unsuccessful, and/or the third Msg3 is considered as failed/unsuccessful. In response to (receiving) the second Msg2, the first device may not respond with a D2R message, the second device may transmit a fourth Msg3, and/or the third device may transmit a fifth Msg3. The first device may consider transmission of the first Msg3 and/or (contention resolution) of/in the random access (procedure) of the first device is successful. The second device may consider transmission of the second Msg3 and/or (contention resolution) of/in the random access (procedure) of the second device is not successful and/or is failed. The third device may consider transmission of the third Msg3 and/or (contention resolution) of/in the random access (procedure) of the third device is not successful and/or is failed/unsuccessful. The fourth Msg3 may be the same as the second Msg3. The fourth Msg3 may be a retransmission of the second Msg3. The fifth Msg3 may be the same as the third Msg3. The fifth Msg3 may be a retransmission of the third Msg3.

The reader may store the device ID after acquisition from the device (e.g., after contention resolution/access/inventory). The reader may perform a dedicated (e.g., indicate the device/group ID) R2D transmission (e.g., command) after acquiring the device/group ID(s). The R2D message may include one or multiple ID(s). The device may perform a corresponding D2R transmission (e.g., ACK, upper layer data, and/or device ID) after (or in response to) receiving the R2D transmission (if (at least) the device ID is included).

Preferably in certain embodiments, after the reader acquires/inventories/identifies a device, an identity may be utilized for R2D transmission(s)/reception and/or D2R transmission(s)/reception between the reader and the device. The identity may be any of device ID, group ID, an ID generated by the device, an ID provided/indicated by the reader.

A first timer(s) (or first time duration(s), or starting time(s), and/or ending time(s)) may be configured/applied/used at the reader. The first timer(s) may be a validity timer (for access/command/inventory procedure). The first timer(s) may be a failure (detection) timer. The first timer(s) may be a transmission timer. The first timer(s) may be a processing timer. The first timer(s) and/or first time duration(s) may represent/comprise a time duration when an R2D transmission/reception/(message) processing is or could be ongoing. For example, the first timer may be started or restarted after an R2D transmission (at the reader). The first timer may be restarted upon receiving (all of the) corresponding D2R transmission(s) (at the reader). The first timer may be stopped upon receiving (all of the) corresponding D2R transmission(s) (at the reader) (and if there is no corresponding (R2D/D2R) transmission). The R2D transmission and/or the corresponding D2R transmission may be considered failed (or not successful) upon the expiry/expiration of the first timer. The R2D transmission and/or the corresponding D2R transmission may not be considered failed (or not successful) when the first timer is running. Upon the expiry/expiration of the first timer (at the reader), the reader may perform a R2D retransmission. Alternatively and/or additionally, the reader may perform (another) R2D transmission to the device(s) in a subset of devices in the R2D transmission (e.g., only some of the devices indicated in the R2D transmission have unsuccessful transmission/reception).

For example, the reader may store the random ID (e.g., included in Msg1 transmission) after acquisition from the device after Msg1 transmission/reception. The reader may transmit Msg2 after receiving one or more Msg1 transmissions from one or multiple devices. The Msg2 may include one or multiple (random) IDs (of the one or multiple devices) (e.g., received in the corresponding Msg1 transmission). The device may perform a corresponding Msg3 transmission (e.g., device ID, upper layer data) after (or in response to) receiving the Msg2, if (at least) the (corresponding) random ID is included. If (at least) the Msg3 of (some of) the device(s) is not received or decoded successfully by the reader, the reader may transmit another Msg2 (e.g., Msg2 retransmission) to the (failed) device(s) (e.g., with unsuccessful Msg3 reception or decoding). The reader may include the random ID(s) of the (failed) device(s) in the another Msg2. The device may perform another corresponding Msg3 transmission (e.g., Msg3 retransmission) in response to receiving the another Msg2, if (at least) the (corresponding) random ID of the device is included in the another Msg2. The another corresponding Msg3 transmission may or may not contain/include the same information/message/data as the (first) corresponding Msg3 transmission (e.g., in response to the (first) Msg2).

Alternatively and/or additionally, the first timer(s) (or the first time duration(s), or starting time(s) and/or ending time(s)) may be configured/utilized at the device. The first timer and/or the first time duration may represent/comprise a processing time of the R2D reception/decoding and generation of the corresponding D2R transmission. For example, the first timer may be started or restarted after an R2D reception (at the device). The first timer may be restarted upon performing the corresponding D2R transmission (at the device). The first timer may be stopped upon performing the corresponding D2R transmission (at the device) (and if there is no corresponding (D2R) transmission). The R2D transmission and/or the corresponding D2R transmission may be considered failed (or not successful) upon the expiry/expiration of the first timer. The R2D transmission and/or the corresponding D2R transmission may not be considered failed (or not successful) when the first timer is running. Upon the expiry/expiration of the first timer (at the device), the device may not (start to) perform the corresponding D2R transmission. Upon the expiry/expiration of the first timer (at the device), the device may stop generation of the corresponding D2R transmission.

A second timer (or second time duration, or starting time and/or ending time) may be configured at the reader. Preferably in certain embodiments, the second timer (or second time duration, or starting time and/or ending time) may be configured/utilized at the device. The second timer may be a validity timer. The second timer may be a failure (detection) timer. The second timer and/or second time duration may represent/comprise a time duration when a (known/inventoried/identified) device is available for (R2D/D2R) transmission/reception. Preferably or alternatively in certain embodiments, the second timer and/or the second time duration may represent/comprise a time duration that the device keeps active/monitoring on R2D reception and/or D2R transmission. Preferably or alternatively in certain embodiments, the second timer and/or the second time duration may represent/comprise a time duration that the identity is valid for R2D transmission(s)/reception(s) and/or D2R transmission(s)/reception(s) between the reader and the device. For example, the (second) timer may be started or restarted after an R2D transmission (at the reader) or after an R2D reception (at the device). The (second) timer may be restarted upon receiving a corresponding D2R transmission (at the reader) or upon performing the corresponding D2R transmission (at the device). The procedure (e.g., command/access) may be considered failed (or not successful) upon the expiry/expiration of the (second) timer. The procedure (e.g., command/access) may not be considered failed (or not successful) when the (second) timer is running. Upon the expiry/expiration of the (second) timer, the reader may perform an inventory procedure for operating/accessing/inventorying the device, if needed. Alternatively and/or additionally, upon the expiry/expiration of the (second) timer, the reader may perform an inventory procedure following a command procedure. Alternatively and/or additionally, upon the expiry/expiration of the (second) timer, the reader may report a failure (of the procedure) to the network, e.g., operation/service with the device is not completed. Preferably in certain embodiments, the reader may perform an R2D transmission/message/signal to stop the second timer or the second time duration, and/or the device may stop the second timer or the second time duration accordingly. Preferably in certain embodiments, when the second timer stops or expires, the device may not maintain/utilized the identity for R2D transmission(s)/reception(s) and/or D2R transmission(s)/reception(s) between the reader and the device. The length of the second timer may be associated with the device (energy/memory) storage. The length of the second timer may be associated with the device current stored power/energy. The length of the second timer may be provided/indicated/suggested by the device. The length of the second timer may be associated with the maximum (or tolerant) latency. The length of the second timer may be multiple of the length of the first timer.

Alternatively and/or additionally, a second counter and/or a determined/(pre)defined threshold (associated with the second counter) may be configured at the reader. For example, the second counter may increment by 1 after an R2D transmission (at the reader). The second counter may be reset upon receiving a corresponding D2R transmission at the reader. The procedure (e.g., command/access) may be considered failed (or not successful) if (at least) the second counter equals to (or is larger than) the determined/(pre)defined threshold. The procedure (e.g., command/access) may not be considered failed (or not successful) if (at least) the (second) counter is smaller than the determined/(pre)defined threshold. Upon the threshold being met, the reader may perform an inventory procedure for operating/accessing/inventorying the device, if needed. Alternatively and/or additionally, upon the threshold being met, the reader may perform an inventory procedure following a command procedure. Alternatively and/or additionally, upon the threshold being met, the reader may report a failure (of the procedure) to the network, e.g., operation/service with the device is not completed. The value of the threshold may be associated with the device (energy/memory) storage. The value of the threshold may be associated with the maximum (or tolerant) latency.

Throughout the present disclosure, the inventory procedure may include a (R2D) paging message and a (D2R) transmission. The paging message may include none, or one or multiple device/group ID(s). The (D2R) transmission may include a device ID (of a device). The ID may be or comprise a random value, temporary number, RNTI, and/or preamble number. The ID may be selected/generated/determined by the device. The ID may be (pre-)configured, (pre-)defined, indicated, and/or assigned by the network or the device. The ID may be temporary. The ID may be permanent.

Throughout the present disclosure, the device ID (e.g., device ID in the R2D message, device ID in the initial trigger message, device ID in the (first) D2R transmission) may be/comprise/represent any of a random value, temporary number, RNTI, preamble number, an identity selected/generated/determined by the device, and/or an identity (pre-)configured, (pre-)defined, indicated, and/or assigned by the network or the device.

One or more of the above embodiment(s), concept(s), method(s), and/or example(s) of resource indication could be combined, in whole or in part, or applied/used separately.

Throughout the present disclosure, the “device” may be or be replaced by an “Ambient IoT device”. The device may receive carrier wave(s) from a reader. The device may receive carrier wave(s) from a node other than the reader.

Throughout the present disclosure, the Network (“NW”) may be, comprise, or be replaced by a “network node”, a “reader”, an “intermediate node”, or a “cell”.

Throughout the present disclosure, the Ambient IoT-related operation may be/comprise any of an access procedure, contention-based access procedure, contention-free access procedure, inventory procedure/operation, and/or communication procedure/operation (for Ambient IoT devices).

Throughout the present disclosure, the intermediate node may be/mean a relay, Integrated Access Backhaul (IAB) node, repeater which is capable of Ambient IoT. The intermediate node be/mean a UE capable of Ambient IoT. The intermediate node may be/mean or replaced as an intermediate UE. The intermediate node may access or connect to the network node.

An R2D transmission may be a transmission from a reader/intermediate node to a device. An R2D data may be (available) data on a reader/intermediate node side and/or data to be transmitted from a reader/intermediate node to a device. An R2D transmission and/or R2D data may comprise an indication, configuration, signaling, and/or message from a reader/intermediate node. An R2D reception may be a reception of an R2D transmission.

A D2R transmission may be a transmission from a device to a reader/intermediate node. A D2R data may be (available) data on a device side and/or data to be transmitted from a device to a reader/intermediate node. A D2R transmission and/or D2R data may comprise an indication, signaling, and/or message from a device. A D2R resource and/or Physical (Ambient IoT) Device (to) Reader Channel (PDRCH) resource may be or comprise a UL grant and/or resource provided from the reader/NW/intermediate node, used by the device and/or used to transmit/perform D2R transmission.

Throughout the present disclosure, the PDRCH may be or be referred to as a channel for transmission from device to reader. The PDRCH may be or be referred to as a (physical) channel for Ambient IoT. The PDRCH may be or be referred to a (physical) channel for D2R (data/control) transmission. The PDRCH may comprise Common Control Channel (CCCH), Physical Random Access Channel (PRACH), Random Access Channel (RACH), Physical Uplink Shared Channel (PUSCH), and/or Physical Uplink Control Channel (PUCCH). An R2D transmission may be transmit via a PRDCH. The (data and/or signaling) transmission from reader to device/UE may be via PRDCH.

Throughout the present disclosure, the PRDCH may be or be referred to as a channel for transmission from reader to device. The PRDCH may be or be referred to as a (physical) channel for Ambient IoT. The PRDCH may be or be referred to as a (physical) channel for R2D (data/control) transmission. The PRDCH may comprise Physical Downlink Shared Channel (PDSCH) and/or Physical Downlink Control Channel (PDCCH). A D2R transmission may be transmit via a PDRCH. The (data and/or signaling) transmission from device/UE to reader may be via PDRCH.

Throughout the present disclosure, a scheduling may be one or more PDRCH resources for D2R transmissions and/or one or more PRDCH resources for R2D receptions. The scheduling may be (an indication of) a timing and/or frequency.

Throughout the present disclosure, the following may be interchangeable: suggested, preferred, expected, required, and/or estimated.

Throughout the present disclosure, the following may be interchangeable: “initiate a procedure”, “perform a procedure”, “trigger a procedure”, and/or “execute a procedure.”

Throughout the present disclosure, the “transmission” may be replaced by “message”.

Throughout the present disclosure, the following may be interchangeable: “R2D message” and/or “R2D transmission”.

Throughout the present disclosure, the following may be interchangeable: “D2R message” and/or “D2R transmission”.

Throughout the present disclosure, the “R2D message/transmission” may be referred to (or include) a new transmission or a retransmission of (at least) any of the following: (A-IoT) paging message, initial trigger message, (A-IoT) Msg2, (A-IoT) Msg4, and/or command message.

Throughout the present disclosure, the “D2R message/transmission” may be referred to (or include) a new transmission or a retransmission of (at least) any of the following: (A-IoT) Msg1, random ID, (A-IoT) Msg3, upper layer data, and/or device ID.

The UE/device may receive a first signaling from the reader. The UE/device may perform (or initiate) a first procedure in response to (or based on) the first signaling. The first signaling may be a query, a paging, a command, a Layer 2 (L2) signaling (e.g., Medium Access Control (MAC) Control Element (CE)), a Layer 1 (L1) signaling (e.g., PRDCH, R2D control information) and/or an R2D signaling. The first signaling may be received by a UE/device, multiple UEs/devices, or one or more groups of UEs/devices. The first signaling may be used to trigger (or indicate) the first procedure. The first signaling may indicate which/what (kind of) UE(s)/device(s) should respond to the first signaling. The first signaling may indicate which/what (kind of) UE(s)/device(s) is allowed to perform (or initiate) the first procedure. The first signaling may indicate which/what (kind of) data/information is requested to report/provide. The first signaling may indicate configuration(s)/resource(s) to be used for the first procedure.

The first procedure may be an (initial) access procedure, an RA procedure, an inventory procedure, a command procedure, and/or an “inventory and command” procedure for Ambient IoT. The first procedure may be 2-step or 4-step. A 2-step first procedure may comprise a first signaling, a D2R transmission (e.g., a first transmission), and an R2D transmission (e.g., a second transmission). A 4-step first procedure may comprise a first signaling, two D2R transmissions (e.g., a first transmission and a third transmission), and two R2D transmissions (e.g., a second transmission and a fourth transmission). A 4-step first procedure may comprise a first signaling, two D2R transmissions (e.g., a first transmission and a third transmission), and an R2D transmission (e.g., a second transmission). The first procedure may be contention-based or contention free. The UE may access the NW/intermediate node, receive signaling/message/configuration, and/or transmit (D2R) data via the first procedure. Throughout the present disclosure, the following may be interchangeable: RA, access, initial access, and/or (Ambient IoT) transmission. The resource(s) and/or configuration(s) for the first procedure may comprise PDRCH resource(s), PDRCH occasion(s), frequency and/or band, e.g., for D2R transmission. The resource(s) and/or configuration(s) for the first procedure may comprise a parameter, random number, group number, and/or assistance information, e.g., for D2R transmission.

In response to receiving the first signaling, the UE/device may trigger/perform the first procedure and/or the following transmission. In the first procedure, the UE/device may transmit a first transmission to the NW/reader. The NW/reader may transmit a second transmission to the UE in response to reception/detection of the first transmission. In response to or after transmitting the first transmission, the UE/device may receive a second transmission from the NW/reader. In response to receiving the second transmission, the UE/device may transmit a third transmission to the NW/reader. The NW/reader may transmit a fourth transmission to the UE/device in response to reception of the third transmission. The NW/reader may not transmit the fourth transmission to the UE/device in response to reception of the third transmission. In response to or after transmitting the third transmission, the UE/device may or may not receive a fourth transmission from the NW/reader. In response to receiving the fourth transmission, the UE/device may transmit a fifth transmission to the NW/reader.

The first transmission may be, comprise, and/or be replaced by a first message and/or Msg1. The first transmission may be/comprise information of a random number, information of a preamble number, and/or information of an (access) ID selected/generated/determined by the UE. The first transmission may be/comprise information of a device/UE ID, report, assistance information, D2R data, and/or information from the UE.

The second transmission may be, comprise, and/or be replaced by a second message and/or Msg2. The second transmission may be a response to the first transmission, an acknowledge, DL/R2D command, R2D data, and/or a scheduling. The second transmission may indicate, identify, and/or correspond to the first transmission. The second transmission may provide resource(s) for the following D2R transmissions, e.g., the third transmission. The second transmission may indicate, notify, and/or allow the third transmission. Alternatively and/or additionally, the second transmission may not (explicitly) provide resource(s) for the following D2R transmissions (e.g., the resource(s) for the following D2R transmissions is provided in the first signaling).

The third transmission may be, comprise, and/or be replaced by a third message and/or Msg3. The third transmission may be/comprise information of a device/UE ID, a feedback (of the second transmission), report, assistance information, D2R data, and/or information from the UE.

The fourth transmission may be, comprise, and/or be replaced by a fourth message and/or Msg4. The fourth transmission may be a response to the third transmission, an acknowledge, DL/R2D command, R2D data, and/or a scheduling. The fourth transmission may indicate, identify, and/or correspond to the third transmission. The fourth transmission may provide resource(s) for the following D2R transmissions. The fourth transmission may indicate, notify, and/or allow the fifth transmission.

The fifth transmission may be, comprise and/or be replaced by a fifth message and/or Msg5. The fifth transmission may be/comprise a feedback (of the fourth transmission), report, assistance information, D2R data, and/or information from the UE.

The first transmission, third transmission, and fifth transmission may be D2R transmissions and/or PDRCH transmissions. The first signaling, second transmission and fourth transmission may be R2D transmissions and/or PRDCH transmissions. The fourth transmission and/or the fifth transmission may be a subsequent transmission during or after the first procedure. More details regarding the first procedure could be found in agreements of 3GPP meetings.

During the first procedure, the NW/reader would provide PDRCH resource(s) for D2R transmission(s). However, the reader could not always predict the pending buffered data in the device/UE. For instance, some D2R data would come (e.g., come to a MAC layer) after the device/UE receives the first signaling. It may mean that the received first signaling may trigger/induce some D2R data coming into the device/UE. There may be or may not be data segmentation on the device/UE side. The device/UE may not be able to transmit all the data over one allocated resource, e.g., if data segmentation is not supported and the one allocated resource cannot accommodate all the data. It would be beneficial if the NW/reader could be aware of the data volume for the D2R data transmission, so that the NW/reader can allocate the proper amount of radio resources for the device/UE.

In Rel-19 A-IoT, each D2R transmission is triggered by an R2D transmission and is transmitted via PDRCH resources provided by the reader. To schedule PDRCH resources properly, the reader needs to know the expected amount of D2R data. And the reader could derive a rough data size with assistance information from the Core Network (CN), especially for an inventory case. However, for a command procedure, there may be D2R data coming into the device after receiving an R2D transmission with a command. The device may not be able to transmit all the D2R data over one D2R transmission scheduled with the command message. Subsequent transmission(s) would be needed depending on how much data the device has. Given that A-IoT devices have ultra-low complexity and limited power, a lightweight method should be designed to let the reader be aware of the status of the D2R data on a device.

In response to receiving the first signaling, e.g., an R2D transmission from the reader, the device may trigger/perform a D2R transmission. The R2D transmission may comprise scheduling information of the D2R transmission. Preferably in certain embodiments, the device may determine/derive an allocated/determined/derived resource size (e.g., time-frequency resource size) based on the scheduling information of the D2R transmission. Preferably in certain embodiments, the device may determine/derive an indicated/determined/derived D2R data size (e.g., an indicated/determined/derived data packet size, an indicated/determined/derived Transport Block (TB) size, an indicated/determined/derived MAC Protocol Data Unit (PDU) size) based on the scheduling information of the D2R transmission.

To solve the issue, a device could indicate, transmit, and/or report a first information to a reader, e.g., during a first procedure as described above, and/or in a D2R transmission. The first information may be related to pending/triggered buffered data (size). The pending/triggered buffered data may be transmitted in a D2R transmission, e.g., a first transmission or a third transmission during the first procedure. The pending/triggered buffered data may be transmitted in multiple D2R transmissions, e.g., a first transmission, a third transmission, and/or a fifth transmission during the first procedure. The pending/triggered buffered data may arrive at the device and/or become available in response to receiving the first signaling as described above (e.g., a command). The pending/triggered buffered data may arrive at the device and/or become available in response to the triggering of the first procedure. Preferably in certain embodiments, the pending/triggered buffered data may arrive at the device and/or become available before receiving the first signaling. Preferably or alternatively in certain embodiments, the pending/triggered buffered data may arrive at the device and/or become available after receiving the first signaling. The pending/triggered buffered data may be/comprise D2R data corresponding to the first signaling.

The first information may be an indication. The first information may be a report. The first information may be a D2R control information and/or a D2R timing acquisition signal. The first information may indicate (at least) one or more of the following:
(Whether) there is pending data for transmitting.
The first information may indicate (whether) there is pending, triggered, remaining and/or buffered D2R data for transmitting. For example, if (at least) the first information is transmitted, there may be pending/triggered/remaining/buffered data in the device. If (at least) the first information is not transmitted, there may not be pending/triggered/remaining/buffered data in the device. For example, if (at least) a first format of the first information (e.g., a first value) is transmitted, there may be pending/triggered/remaining/buffered data in the device. If (at least) a second format of the first information (e.g., a second value) is transmitted, there may not be pending/triggered/remaining/buffered data in the device.
(Early) termination of a PDRCH transmission.
The first information may indicate (early) termination of PDRCH scheduling and/or transmission. For example, if (at least) the first information is transmitted, there may not be pending/triggered/remaining/buffered data in the device. If (at least) the first information is transmitted, there may be pending/remaining/buffered data in the device.

The device may receive an R2D transmission indicating PDRCH resources for a corresponding D2R transmission. For example, the device may receive a first signaling indicating first PDRCH resources. The device may transmit a first transmission using the first PDRCH resources. The device may receive a second transmission indicating second PDRCH resources. The device may transmit a third transmission using the second PDRCH resources. The device may (determine to) trigger, indicate, transmit, and/or report the first information in response to (at least) one or more of the following events. Alternatively and/or additionally, the device may (determine to) trigger, indicate, transmit and/or report the first information to indicate (at least) one or more of the following events:
Corresponding PDRCH (or D2R transmission) does not accommodate all (pending) D2R data.
The PDRCH resources (indicated in an R2D transmission) may not (be able to) accommodate all pending D2R data (for corresponding D2R transmission) in the device. The PDRCH resources size (indicated in an R2D transmission) or the indicated/determined/derived data size may be smaller than the size of the pending D2R data (for corresponding D2R transmission) in the device.
Receiving a network/reader signaling.
The network/reader signaling may be a first signaling, a command, a second transmission, and/or a fourth transmission. The network/reader signaling may request the first information from the device. The network/reader signaling may ask the amount of specific data in the device. The network/reader signaling may indicate the type or information of specific data. The specific data may be related to at least specific data type(s) or logical channel(s). The network/reader signaling may be a configuration.

Whether to use the first information, e.g., for a D2R transmission, may be controlled by network (or reader). For example, the network signaling may indicate whether the device (or the D2R transmission) should include the first information. If (at least) the network/reader signaling indicates the device to use/report or transmit the first information, the device may include the first information in the D2R transmission (and/or perform the D2R transmission based on or by using the first information). If (at least) the network/reader signaling indicates the device not to use/report/transmit the first information (and/or does not indicate the device to use/report the first information), the device may not include the first information in the D2R transmission (and/or perform the D2R transmission without using the first information).

Alternatively and/or additionally, the device may always trigger, indicate, transmit, and/or report the first information in response to (at least) one or more of the following events:
Receiving a first signaling;
Transmitting a first D2R transmission in a first procedure;
Triggering a specific type of first procedure (e.g., 2-step procedure, 4-step procedure, contention-based procedure, contention free procedure, command procedure); and/or
Requiring a specific type of data (e.g., based on data type, Quality of Service (QoS)).

The first information may be indicated, transmitted, and/or reported in the first transmission, the third transmission, and/or the fifth transmission during the first procedure. The first information may be (or may be indicated, transmitted, and/or reported in) a preamble, a midamble, a postamble, a D2R control information, and/or a D2R timing acquisition signal for a PDRCH (transmission). The first information may be indicated, transmitted, and/or reported in an L1 signaling and/or a L2 signaling (e.g., MAC CE, information element).

To solve the issue, the device may determine a first indication in a first D2R message based on whether there is remaining data after transmitting the first D2R message. The first indication may indicate there is more data after transmitting the first D2R message. The device may transmit the first indication indicating a first value if there is remaining data after transmitting the first D2R message. The device may transmit the first indication indicating a second value if there is not remaining data after transmitting the first D2R message. The present invention would allow an Ambient IoT device to inform the network that there is remaining data with less signaling.

One or more of above embodiment(s), concept(s), method(s), example(s) could be combined, in whole or in part. Throughout the present disclosure, the pending (D2R) data may be and/or comprise available D2R data, remaining D2R data (e.g., after a PDRCH transmission), pending D2R data (e.g., triggered by a first procedure), corresponding header(s), and/or corresponding control information. Throughout the present disclosure, PDRCH resources, PDRCH scheduling, D2R grants, D2R resources, and/or D2R scheduling could be interchangeable.

The UE may receive configurations related to Ambient IoT. The UE may receive configurations and/or resources for performing the first procedure. The UE may receive configurations related to first information reporting, e.g., as described above. The UE may receive configurations for triggering/reporting/providing/determining a first information. The resource(s) and/or configuration(s) may comprise PDRCH (transmission) resource(s), occasion(s), channel resource(s), frequency resources and/or (sub-) band(s), e.g., for D2R transmission. The resource(s) and/or configuration(s) may comprise parameters, random numbers, group numbers, and/or assistance information, e.g., for D2R transmission. The UE may monitor/receive the PRDCH in/during the first procedure.

Throughout the present disclosure, a scheduling may be one or more PDRCH resource(s) for D2R transmission(s) and/or one or more PRDCH resource(s) for R2D reception(s). The scheduling may be (an indication of) a timing and/or frequency.

Throughout the present disclosure, the UE may be a device used for Ambient IoT. The UE may be a device capable of Ambient IoT. The UE may be an NR device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: (Ambient IoT) UE, (Ambient IoT) device. Throughout the present disclosure, the following may be interchangeable: normal UE, legacy UE.

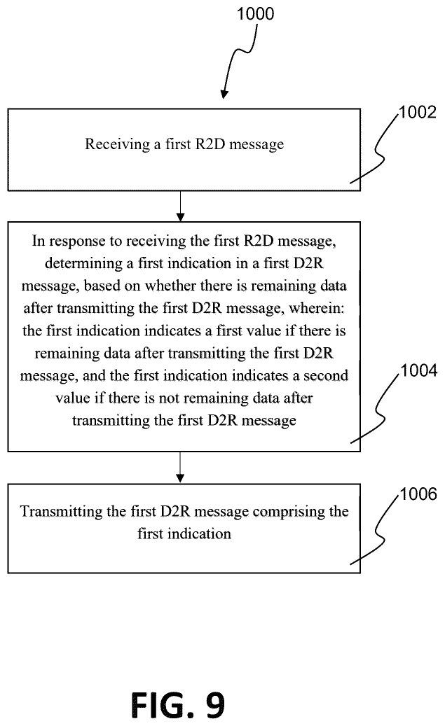

Referring to FIG. 9, with this and other concepts, systems, and methods of the present invention, a method 1000 for a UE in a wireless communication system comprises receiving a first R2D message (step 1002), in response to receiving the first R2D message, determining a first indication in a first D2R message, based on whether there is remaining data after transmitting the first D2R message, wherein: the first indication indicates a first value if there is remaining data after transmitting the first D2R message, and the first indication indicates a second value if there is not remaining data after transmitting the first D2R message (step 1004), and transmitting the first D2R message comprising the first indication (step 1006).

In various embodiments, the first indication indicates there is more data after transmitting the first D2R message and/or there is remaining D2R data at the UE.

In various embodiments, the first R2D message is or comprises a command, a scheduling information of the first D2R message, and/or R2D data.

In various embodiments, the first D2R message comprises a response corresponding to the first D2R message and/or an information of the UE.

In various embodiments, the first D2R message is transmitted using resources based on the scheduling information.

In various embodiments, the UE performs a command procedure, and/or wherein the first R2D message is received in the command procedure, and/or wherein the first D2R message and/or the first indication is transmitted in the command procedure.

In various embodiments, the determination (on that there is remaining data after transmitting the first D2R message) is based on at least one or more of the following: a resource size of the first D2R message is smaller than an available or pending data size (before generating the first D2R message), and/or the available or pending data size (before generating the first D2R message) is larger than the resource size of the first D2R message, and/or the first D2R message cannot accommodate all of the available or pending data, and/or the resource size of the first D2R message cannot accommodate all of the available or pending data, and/or there is more and/or remaining data after transmitting the first D2R message.

In various embodiments, the available or pending data comprises at least D2R data to be transmitted, pending or available D2R data at the UE, corresponding header(s), and/or corresponding control information.

In various embodiments, the UE is an Ambient IoT device.

In various embodiments, the first R2D message is transmitted from a reader, the first D2R message is transmitted to the reader, and/or the reader is a network or another UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first R2D message; (ii) in response to receiving the first R2D message, determine a first indication in a first D2R message, based on whether there is remaining data after transmitting the first D2R message, wherein: the first indication indicates a first value if there is remaining data after transmitting the first D2R message, and the first indication indicates a second value if there is not remaining data after transmitting the first D2R message; and (iii) transmit the first D2R message comprising the first indication. Moreover, the CPU 308 can execute the program code 312 to perform all of the described actions, steps, and methods described above, below, or otherwise herein.

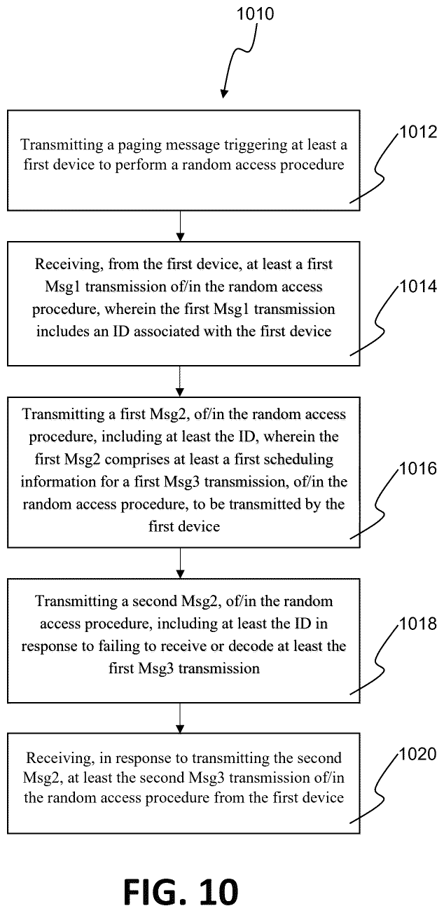

Referring to FIG. 10, with this and other concepts, systems, and methods of the present invention, a method 1010 for a reader in a wireless communication system comprises transmitting a paging message triggering at least a first device to perform a random access procedure (step 1012), receiving, from the first device, at least a first Msg1 transmission of/in the random access procedure, wherein the first Msg1 transmission includes an ID associated with the first device (step 1014), transmitting a first Msg2, of/in the random access procedure, including at least the ID, wherein the first Msg2 comprises at least a first scheduling information for a first Msg3 transmission, of/in the random access procedure, to be transmitted by the first device (step 1016), transmitting a second Msg2, of/in the random access procedure, including at least the ID in response to failing to receive or decode at least the first Msg3 transmission (step 1018), and receiving, in response to transmitting the second Msg2, at least the second Msg3 transmission of/in the random access procedure from the first device (step 1020).

In various embodiments, the paging message triggers at least a second device to perform a random access procedure, the reader receives a second Msg1 transmission from the second device, wherein the second Msg1 transmission includes a second ID associated with the second device, the reader transmits the first Msg2, including at least the second ID, wherein the first Msg2 comprises at least a third scheduling information for a third Msg3 transmission from the second device, and the reader receives or decodes the third Msg3 transmission successfully from the second device.

In various embodiments, the second Msg2 does not include the second ID, in response to at least the reader receiving and decoding the third Msg3 transmission successfully, and/or the second Msg2 excludes from including any ID of a device when the reader successfully receives and decodes a Msg3 transmission from the device.

In various embodiments, the ID is a random ID generated or selected by the first device.

In various embodiments, the first Msg3 transmission comprises upper layer data and/or a device ID of the first device.

In various embodiments, the second Msg3 transmission comprises the upper layer data and/or the device ID of the first device.

In various embodiments, the first Msg3 is the same as the second Msg3 and/or the second Msg3 transmission is a retransmission of the first Msg3 transmission.

In various embodiments, the third Msg3 transmission comprises upper layer data and/or a device ID of the second device.

In various embodiments, the random access procedure is a contention-based access procedure.

In various embodiments, the second Msg2 comprises or does not comprise at least a second scheduling information for the second Msg3 transmission from the first device.

In various embodiments, the first Msg2 includes a first one or more IDs of a first one or more devices (e.g., (at least) the first device and/or the second device) in response to the reader receiving one or more Msg1 transmissions from the first one or more devices (e.g., (at least) the first device and/or the second device), and/or the second Msg2 includes a second one or more IDs of a second one or more device (e.g., (at least) the first device) in response to the reader failing to receive or decode one or more Msg3 transmissions from the second one or more devices (e.g., (at least) the first device).

In various embodiments, the first Msg1 transmission, the first Msg3 transmission, and/or the second Msg3 transmission are received in the random access procedure. The first Msg2 and/or the second Msg2 are transmitted in the random access procedure.

In various embodiments, the first Msg1 transmission (including the ID associated with the first device) comprises or is (replaced as) a first D2R transmission which comprises a first D2R message including the ID associated with the first device.

In various embodiments, the first Msg2 (including at least the ID) comprises or is (replaced as) a first R2D message including at least the ID (in response to the first D2R message).

In various embodiments, the second Msg2 (including at least the ID) comprises or is (replaced as) a second R2D message including at least the ID (in response to the first D2R message).

In various embodiments, the first Msg3 transmission comprises or is (replaced as) a second D2R transmission which comprises the upper layer data and/or the device ID of the first device (in response to the first R2D message).

In various embodiments, the second Msg3 transmission comprises or is (replaced as) a third D2R transmission which comprises the upper layer data and/or the device ID of the first device (in response to the second R2D message).

In various embodiments, the second D2R transmission and the third D2R transmission comprise the same D2R message. The first Msg3 transmission and the second Msg3 transmission comprise the same D2R message.

In various embodiments, the second Msg1 transmission (including the second ID associated with the second device) comprises or is (replaced as) a fourth D2R transmission which comprises a fourth D2R message including the second ID associated with the second device.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a paging message triggering at least a first device to perform a random access procedure; (ii) receive, from the first device, at least a first Msg1 transmission of/in the random access procedure, wherein the first Msg1 transmission includes an ID associated with the first device; (iii) transmit a first Msg2, of/in the random access procedure, including at least the ID, wherein the first Msg2 comprises at least a first scheduling information for a first Msg3 transmission, of/in the random access procedure, to be transmitted by the first device; (iv) transmit a second Msg2, of/in the random access procedure, including at least the ID in response to failing to receive or decode at least the first Msg3 transmission; and (v) receive, in response to transmitting the second Msg2, at least the second Msg3 transmission of/in the random access procedure from the first device. Moreover, the CPU 308 can execute the program code 312 to perform all of the described actions, steps, and methods described above, below, or otherwise herein.

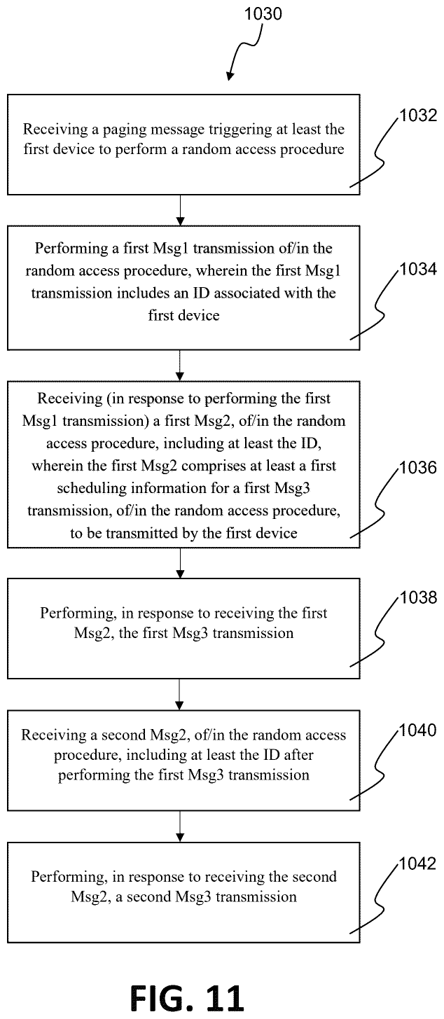

Referring to FIG. 11, with this and other concepts, systems, and methods of the present invention, a method 1030 for a first device in a wireless communication system comprises receiving a paging message triggering at least the first device to perform a random access procedure (step 1032), performing a first Msg1 transmission of/in the random access procedure, wherein the first Msg1 transmission includes an ID associated with the first device (step 1034), receiving (in response to performing the first Msg1 transmission) a first Msg2, of/in the random access procedure, including at least the ID, wherein the first Msg2 comprises at least a first scheduling information for a first Msg3 transmission, of/in the random access procedure, to be transmitted by the first device (step 1036), performing, in response to receiving the first Msg2, the first Msg3 transmission (step 1038), receiving a second Msg2, of/in the random access procedure, including at least the ID after performing the first Msg3 transmission (step 1040), and performing, in response to receiving the second Msg2, a second Msg3 transmission (step 1042).

In various embodiments, the ID is a random ID generated or selected by the first device.

In various embodiments, the first Msg3 transmission comprises upper layer data and/or a device ID of the first device.

In various embodiments, the second Msg3 transmission comprises the upper layer data and/or the device ID of the first device.

In various embodiments, the first Msg3 is the same as the second Msg3 and/or the second Msg3 transmission is a retransmission of the first Msg3 transmission.

In various embodiments, the random access procedure is a contention-based access procedure.

In various embodiments, the second Msg2 comprises or does not comprise at least a second scheduling information for the second Msg3 transmission from the first device.

In various embodiments, the first Msg1 transmission, the first Msg3 transmission, and/or the second Msg3 transmission are performed in the random access procedure. The first Msg2 and/or the second Msg2 are received in the random access procedure.

In various embodiments, the second Msg2 is received in response to the first Msg3 transmission.

In various embodiments, the first Msg1 transmission (including the ID associated with the first device) comprises or is (replaced as) a first D2R transmission which comprises a first D2R message including the ID associated with the first device.

In various embodiments, the first Msg2 (including at least the ID) comprises or is (replaced as) a first R2D message including at least the ID (in response to the first D2R message).

In various embodiments, the second Msg2 (including at least the ID) comprises or is (replaced as) a second R2D message including at least the ID (in response to the first D2R message).

In various embodiments, the first Msg3 transmission comprises or is (replaced as) a second D2R transmission which comprises the upper layer data and/or the device ID of the first device (in response to the first R2D message).

In various embodiments, the second Msg3 transmission comprises or is (replaced as) a third D2R transmission which comprises the upper layer data and/or the device ID of the first device (in response to the second R2D message).

In various embodiments, the second D2R transmission and the third D2R transmission comprise the same D2R message. The first Msg3 transmission and the second Msg3 transmission comprise the same D2R message.

Referring back to FIGS. 3 and 4, in one or more embodiments from the perspective of a first device in a wireless communication system, the device 300 includes a program code 312 stored in memory 310 of the transmitter. The CPU 308 could execute program code 312 to: (i) receive a paging message triggering at least the first device to perform a random access procedure; (ii) perform a first Msg1 transmission of/in the random access procedure, wherein the first Msg1 transmission includes an ID associated with the first device; (iii) receive (in response to performing the first Msg1 transmission) a first Msg2, of/in the random access procedure, including at least the ID, wherein the first Msg2 comprises at least a first scheduling information for a first Msg3 transmission, of/in the random access procedure, to be transmitted by the first device; (iv) perform, in response to receiving the first Msg2, the first Msg3 transmission; (v) receive a second Msg2, of/in the random access procedure, including at least the ID after performing the first Msg3 transmission; and (vi) perform, in response to receiving the second Msg2, a second Msg3 transmission. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a reader, comprising:
transmitting a paging message triggering at least a first device to perform a random access procedure;
receiving, from the first device, at least a first Msg1 transmission of the random access procedure, wherein the first Msg1 transmission includes an Identification (ID) associated with the first device;
transmitting a first Msg2, of the random access procedure, including at least the ID, wherein the first Msg2 comprises at least a first scheduling information for a first Msg3 transmission, of the random access procedure, to be transmitted by the first device;
transmitting a second Msg2, of the random access procedure, including at least the ID in response to failing to receive or decode at least the first Msg3 transmission; and
receiving, in response to transmitting the second Msg2, at least the second Msg3 transmission of the random access procedure from the first device.

2. The method of claim 1, wherein:
the paging message triggers at least a second device to perform a random access procedure;
the reader receives a second Msg1 transmission from the second device, wherein the second Msg1 transmission includes a second ID associated with the second device;
the reader transmits the first Msg2, including at least the second ID, wherein the first Msg2 comprises at least a third scheduling information for a third Msg3 transmission to be transmitted by the second device; and
the reader receives or decodes the third Msg3 transmission successfully from the second device.

3. The method of claim 2, wherein the second Msg2 does not include the second ID, in response to at least the reader receiving and decoding the third Msg3 transmission successfully, and/or the second Msg2 excludes from including any ID of a device when the reader successfully receives and decodes a Msg3 transmission from the device.

4. The method of claim 1, wherein the ID is a random ID generated or selected by the first device, and/or wherein the first Msg1 transmission including the ID associated with the first device comprises or is a first Device-to-Reader (D2R) transmission which comprises a first D2R message including the ID associated with the first device.

5. The method of claim 1, wherein the first Msg3 transmission comprises upper layer data and/or a device ID of the first device, and/or the second Msg3 transmission comprises the upper layer data and/or the device ID of the first device, or wherein the first Msg3 transmission comprises or is a second D2R transmission which comprises the upper layer data and/or the device ID of the first device, and/or the second Msg3 transmission comprises or is a third D2R transmission which comprises the upper layer data and/or the device ID of the first device.

6. The method of claim 1, wherein the random access procedure is a contention-based access procedure.

7. The method of claim 1, wherein the second Msg2 comprises or does not comprise at least a second scheduling information for the second Msg3 transmission to be transmitted by the first device.

8. The method of claim 1, wherein:
the first Msg2 includes a first one or more IDs of a first one or more devices in response to the reader receiving one or more Msg1 transmissions from the first one or more devices, and/or
the second Msg2 includes a second one or more IDs of a second one or more device in response to the reader failing to receive or decode one or more Msg3 transmissions from the second one or more devices, and/or
the first Msg2 including at least the ID comprises or is a first Reader-to-Device (R2D) message including at least the ID, and/or
the second Msg2 including at least the ID comprises or is a second R2D message including at least the ID.

9. A method of a first device, comprising:
receiving a paging message triggering at least the first device to perform a random access procedure;
performing a first Msg1 transmission of the random access procedure, wherein the first Msg1 transmission includes an Identification (ID) associated with the first device;
receiving a first Msg2, of the random access procedure, including at least the ID, wherein the first Msg2 comprises at least a first scheduling information for a first Msg3 transmission, of the random access procedure, to be transmitted by the first device;
performing, in response to receiving the first Msg2, the first Msg3 transmission;
receiving a second Msg2, of the random access procedure, including at least the ID after performing the first Msg3 transmission; and
performing, in response to receiving the second Msg2, a second Msg3 transmission.

10. The method of claim 9, wherein the ID is a random ID generated or selected by the first device, and/or wherein the first Msg1 transmission including the ID associated with the first device comprises or is a first Device-to-Reader (D2R) transmission which comprises a first D2R message including the ID associated with the first device.

11. The method of claim 9, wherein the first Msg3 transmission comprises upper layer data and/or a device ID of the first device, and/or the second Msg3 transmission comprises the upper layer data and/or the device ID of the first device, or wherein the first Msg3 transmission comprises or is a second D2R transmission which comprises the upper layer data and/or the device ID of the first device, and/or the second Msg3 transmission comprises or is a third D2R transmission which comprises the upper layer data and/or the device ID of the first device.

12. The method of claim 9, wherein the random access procedure is a contention-based access procedure.

13. The method of claim 9, wherein the second Msg2 comprises or does not comprise at least a second scheduling information for the second Msg3 transmission to be transmitted by the first device, and/or wherein the first Msg2 including at least the ID comprises or is a first Reader-to-Device (R2D) message including at least the ID, and/or the second Msg2 including at least the ID comprises or is a second R2D message including at least the ID.

14. A reader, comprising:
a memory; and
a processor operatively coupled with the memory, wherein the processor is configured to execute a program code to:
transmit a paging message triggering at least a first device to perform a random access procedure;
receive, from the first device, at least a first Msg1 transmission of the random access procedure, wherein the first Msg1 transmission includes an Identification (ID) associated with the first device;
transmit a first Msg2, of the random access procedure, including at least the ID, wherein the first Msg2 comprises at least a first scheduling information for a first Msg3 transmission, of the random access procedure, to be transmitted by the first device;
transmit a second Msg2, of the random access procedure, including at least the ID in response to failing to receive or decode at least the first Msg3 transmission; and
receive, in response to transmitting the second Msg2, at least the second Msg3 transmission of the random access procedure from the first device.

15. The reader of claim 14, wherein:
the paging message triggers at least a second device to perform a random access procedure;
the reader receives a second Msg1 transmission from the second device, wherein the second Msg1 transmission includes a second ID associated with the second device;
the reader transmits the first Msg2, including at least the second ID, wherein the first Msg2 comprises at least a third scheduling information for a third Msg3 transmission to be transmitted by the second device; and
the reader receives or decodes the third Msg3 transmission successfully from the second device.

16. The reader of claim 14, wherein the second Msg2 does not include the second ID, in response to at least the reader receiving and decoding the third Msg3 transmission successfully, and/or the second Msg2 excludes from including any ID of a device when the reader successfully receives and decodes a Msg3 transmission from the device.

17. The reader of claim 14, wherein the ID is a random ID generated or selected by the first device, and/or wherein the first Msg1 transmission including the ID associated with the first device comprises or is a first Device-to-Reader (D2R) transmission which comprises a first D2R message including the ID associated with the first device.

18. The reader of claim 14, wherein the first Msg3 transmission comprises upper layer data and/or a device ID of the first device, and/or the second Msg3 transmission comprises the upper layer data and/or the device ID of the first device, or wherein the first Msg3 transmission comprises or is a second D2R transmission which comprises the upper layer data and/or the device ID of the first device, and/or the second Msg3 transmission comprises or is a third D2R transmission which comprises the upper layer data and/or the device ID of the first device.

19. The reader of claim 14, wherein the random access procedure is a contention-based access procedure.

20. The reader of claim 14, wherein the second Msg2 comprises or does not comprise at least a second scheduling information for the second Msg3 transmission to be transmitted by the first device, and/or wherein the first Msg2 including at least the ID comprises or is a first Reader-to-Device (R2D) message including at least the ID, and/or the second Msg2 including at least the ID comprises or is a second R2D message including at least the ID.
